(19) United States
(12) Patent Application Publication
(10) Pub. No.: US 2014/0112517 A1
(43) Pub. Date: Apr. 24, 2014

(54) MICROPHONE FEATURES RELATED TO A PORTABLE COMPUTING DEVICE

(71) Applicant: APPLE INC., Cupertino, CA (US)

(72) Inventors: Houtan R. FARAHANI, San Ramon, CA (US); Matthew P. CASEBOLT, Fremont, CA (US); Hilbert T. KWAN, Cupertino, CA (US); William F. LEGGETT, San Francisco, CA (US); Gavin J. REID, Campbell, CA (US)

(73) Assignee: Apple Inc., Cupertino, CA (US)

(21) Appl. No.: 13/870,895

(22) Filed: Apr. 25, 2013

Related U.S. Application Data
(60) Provisional application No. 61/715,799, filed on Oct. 18, 2012.

(51) Int. Cl. H04R 1/02

(52) U.S. Cl. CPC H04R 1/02
USPC 381/365

(57) ABSTRACT

A portable computing device includes one or more microphones that function seamlessly with other components within the portable computing device. In one embodiment, a microphone opening is disposed on a side of the personal computing device and configured to be substantially perpendicular to a user. In another embodiment, two microphones can be disposed on an upper region above a keyboard section and can include a third microphone facing toward a rear portion of the portable computing device. In yet another embodiment, a fixture for providing a bonding pressure to microphones is described.

### CROSS REFERENCE TO RELATED APPLICATIONS

This U.S. patent application claims priority under 35 USC 119(e) to U.S. Provisional Patent Application No. 61/715,799 filed Oct. 18, 2012 entitled “Microphone Features Related to a Portable Computing Device” by Espiritu et al. which is incorporated by reference in its entirety for all purposes.

### TECHNICAL FIELD

The present invention relates generally to portable computing devices. More particularly, the present embodiments relate to microphone arrays for portable computing devices.

### BACKGROUND

Portable computing devices have grown in popularity and capability. Early uses for portable computing devices were often limited to simple computing tasks such as number manipulation and word processing. Present applications can include advanced graphical rendering, musical composition, movie and music presentation and more.

In order to support the ever expanding list of applications desired by users, portable computing devices are including more sophisticated components into the space defined by the enclosure of the device. While users expect more performance and features from their portable computing devices, users also want a compact unit; that is, users want the enclosure to be as compact as feasible.

Including a microphone in a portable computing device can be difficult, especially as the device becomes more compact and increased audio quality and capability is desired. As the portable computing device becomes smaller, internal component density increases which can result in a microphone implementation that can yield poor audio performance.

Therefore, it would be beneficial to provide a portable computing device that can support microphone capabilities within design constraints of the enclosure space.

### SUMMARY

The present application describes various embodiments regarding systems and methods for incorporating microphone openings and microphones into a portable computing device. In one embodiment, a microphone assembly for a portable computing device can include a first microphone opening located on an upper portion of a base portion of the portable computing device, a second microphone opening disposed on a rear facing surface of the base portion, a first microphone coupled to the first microphone opening and a second microphone coupled to the second microphone opening wherein the first and the second microphones are configured to receive audio signals.

In another embodiment, a microphone assembly for a portable computing device can include a first microphone opening disposed on a sideband of a base portion of the portable computing device, a first microphone configured to receive audio signals and a first acoustic cavity, the acoustic cavity can include a first segment and a second segment and is configured to couple the first microphone to the first microphone opening, where the first acoustic cavity is configured to have a frequency response.

A fixture for applying a bonding pressure to a microphone assembly can include a plunger support configured to align with features included in a top case of a portable computing device and a plunger configured to be supported by the plunger support and including a first surface configured to contact a first microphone and a second surface configured to receive pressure and transmit the pressure to the first microphone.

Other apparatuses, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The included drawings are for illustrative purposes and serve only to provide examples of possible structures and arrangements for the disclosed inventive apparatuses and methods for providing portable computing devices. These drawings in no way limit any changes in form and detail that may be made to the invention by one skilled in the art without departing from the spirit and scope of the invention. The embodiments will be readily understood by the following detailed description in conjunction with the accompanying drawings, wherein like reference numerals designate like structural elements, and in which:

FIG. 1 shows a front facing perspective view of an embodiment of the portable computing device in the form of portable computing device in an open (lid) state.

FIG. 2 shows portable computing device in a closed (lid) configuration that shows rear cover and logo.

FIG. 3 shows another embodiment of the portable computing device in the form of portable computing device also in the open state.

FIG. 4 shows microphone region of top case.

FIGS. 5A-5B are cross section views of microphone openings from FIG. 4.

FIG. 6 shows microphone region of top case.

FIGS. 7A and 7B are cross section views of microphone openings shown in FIG. 6.

FIG. 8 is a cross section view of another embodiment of a microphone region on top case.

FIG. 9 is a view of another embodiment of a microphone region.

FIG. 10 shows another view of the microphone region shown in FIG. 9 including a microphone assembly.

FIG. 11 shows an interior view of the top case near the microphone region of FIG. 9.

FIG. 12 shows an interior view of top case near the microphone region of FIG. 9 with a microphone assembly.

FIG. 13 shows an internal view of the top case in the region of a first microphone disposed on an upper region of the top case.

FIG. 14 shows a reverse view of a mounting substrate.

FIG. 15 shows an internal view of a clutch assembly including a second microphone.

FIG. 16 is a cross sectional view A-A of another embodiment of a microphone region configured to include sideband microphone openings as shown in FIG. 4.

FIG. 17 is an interior view of the top case in the region of the cross section shown in FIG. 16.

FIG. 18 is an interior view of the top case in the region of the cross section shown in FIG. 16 including a microphone assembly.

FIG. 19 shows one embodiment of bi-stable spring configured to affix a microphone assembly in place with respect to top case.

FIG. 20 shows a fixture for applying pressure to a microphone assembly to assist in mounting the microphone assembly in top case.

### DETAILED DESCRIPTION

Representative applications of apparatuses and methods according to the presently described embodiments are provided in this section. These examples are being provided solely to add context and aid in the understanding of the described embodiments. It will thus be apparent to one skilled in the art that the presently described embodiments can be practiced without some or all of these specific details. In other instances, well known process steps have not been described in detail in order to avoid unnecessarily obscuring the presently described embodiments. Other applications are possible, such that the following examples should not be taken as limiting.

The following relates to a portable computing device such as a laptop computer, net book computer, tablet computer, etc. The portable computing device can include a multi-part housing having a top case and a bottom case joining at a reveal to form a base portion. The portable computing device can have an upper portion (or lid) that can house a display screen and other related components whereas the base portion can house various processors, drives, ports, battery, keyboard, touchpad and the like. The base portion can be formed of a multipart housing that can include top and bottom outer housing components each of which can be formed in a particular manner at an interface region such that the gap and offset between these outer housing components are not only reduced, but are also more consistent from device to device during the mass production of devices. These general subjects are set forth in greater detail below.

The top case can also include one or more microphones to capture audio signals for recording or processing. Two or more microphones can be used together to determine an audio source direction that can be used to improve audio capture performance. In one embodiment, the spacing between two microphones can correspond to increasing sensitivity to audio signals centered about a selected frequency. In one embodiment, the selected frequency can be around 8 KHz, which can be in a human voice range.

In one embodiment, microphone holes for receiving audio signals can be located in a sideband of the top case. Microphone holes can be coupled to microphones through resonant cavities. The resonant cavities can shape a frequency response of the related microphones. In one embodiment, the resonant cavities can peak or boost the frequency response around 8 KHz. In another embodiment, microphone holes can be positioned on a keyboard web, approximately centered horizontally on the portable computing device. Microphones can be coupled to microphone holes through cavities.

In one embodiment, a cavity can be formed within a fastener that can simultaneously be configured to attach a keyboard to the keyboard web. In yet another embodiment, microphone openings can be disposed on the keyboard web and can be hidden by keycaps.

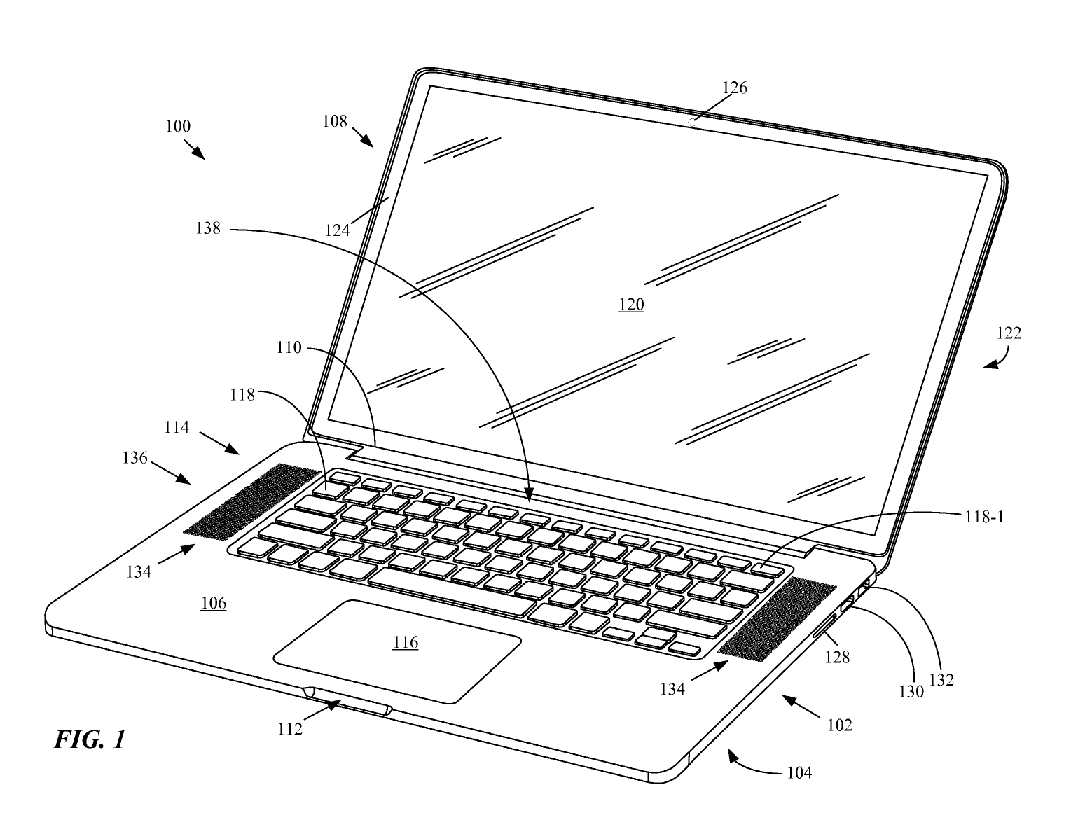

These and other embodiments are discussed below with reference to FIGS. 1-20. However, those skilled in the art will readily appreciate that the detailed description given herein with respect to these figures is for explanatory purposes as the invention extends beyond these limited embodiments.

FIGS. 1-20 show various views of the portable computing device in accordance with various embodiments. FIG. 1 shows a front facing perspective view of an embodiment of the portable computing device in the form of portable computing device 100 in an open (lid) state. Portable computing device 100 can include base portion 102 formed of bottom case 104 fastened to top case 106. Base portion 102 can be pivotally connected to lid portion 108 by way of clutch assembly 110 hidden from view by a cosmetic wall. Base portion 102 can have an overall uniform shape sized to accommodate clutch assembly 110 and inset portion 112 suitable for assisting a user in lifting lid portion 108 by, for example, a finger. Top case 106 can be configured to accommodate various user input devices such as keyboard 114 and touchpad 116. Keyboard 114 can include a plurality of low profile keycap assemblies each having an associated key pad 118. In one embodiment, an audio transducer (not shown) can use selected portions of keyboard 114 to output audio signals such as music. In the described embodiment, a microphone can be located at a side portion of top case 106 that can be spaced apart to improve frequency response of an associated audio circuit.

Each of the plurality of key pads 118 can have a symbol imprinted thereon for identifying the key input associated with the particular key pad. Keyboard 114 can be arranged to receive a discrete input at each keypad using a finger motion referred to as a keystroke. In the described embodiment, the symbols on each key pad can be laser etched thereby creating an extremely clean and durable imprint that will not fade under the constant application of keystrokes over the life of portable computing device 100. In order to reduce component count, a keycap assembly can be re-provisioned as a power button. For example, key pad 118-1 can be used as power button 118-1. In this way, the overall number of components in portable computing device 100 can be commensurably reduced.

Touch pad 116 can be configured to receive finger gesturing. A finger gesture can include touch events from more than one finger applied in unison. The gesture can also include a single finger touch event such as a swipe or a tap. The gesture can be sensed by a sensing circuit in touch pad 116 and converted to electrical signals that are passed to a processing unit for evaluation. In this way, portable computing device 100 can be at least partially controlled by touch.

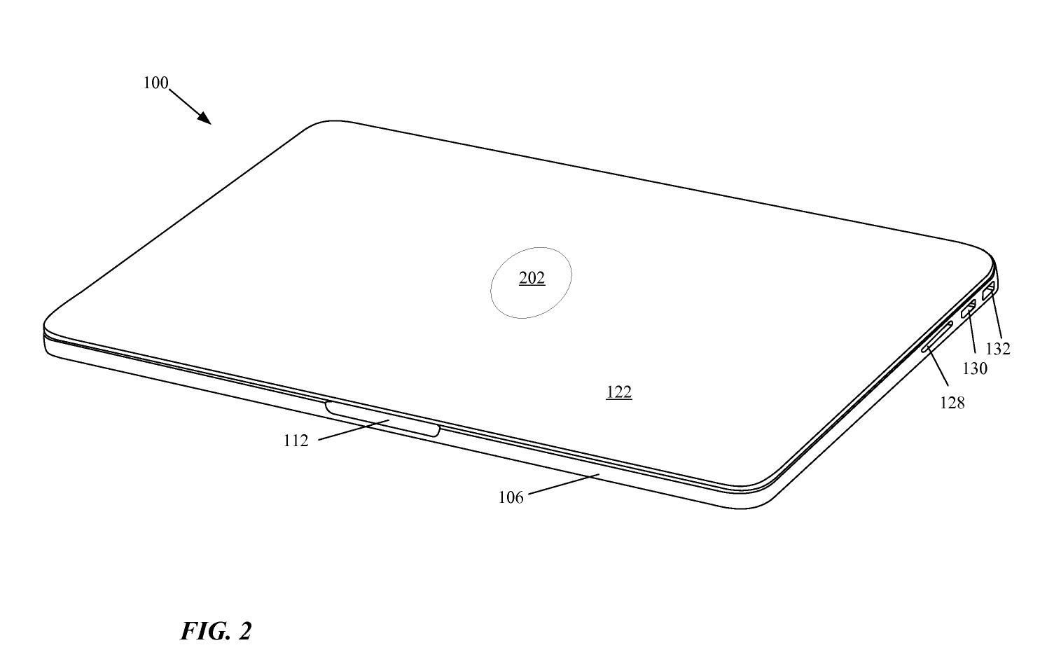

Lid portion 108 can be moved with the aid of clutch assembly 110 from the closed position to remain in the open position and back again. Lid portion 108 can include display 120 and rear cover 122 (shown more clearly in FIG. 2) that can add a cosmetic finish to lid portion 108 and also provide structural support to at least display 120. In the described embodiment, lid portion 108 can include mask (also referred to as display trim) 124 that surrounds display 120. Display trim 124 can be formed of an opaque material such as ink deposited on top of or within a protective layer of display 120. Display trim 124 can enhance the overall appearance of display 120 by hiding operational and structural components as well as focusing attention onto the active area of display 120.

Display 120 can display visual content such as a graphical user interface, still images such as photos as well as video media items such as movies. Display 120 can display images using any appropriate technology such as a liquid crystal display (LCD), OLED, etc. Portable computing device 100 can also include image capture device 126 located on a transparent portion of display trim 124. Image capture device 126 can be configured to capture both still and video images. Lid portion 108 can be formed to have uni-body construction that can provide additional strength and resiliency to lid portion 108 which is particularly important due to the stresses caused by repeated opening and closing. In addition to the increase in strength and resiliency, the uni-body construction of lid portion 108 can reduce overall part count by eliminating separate support features.

Data ports 128-132 can be used to transfer data and/or power between an external circuit(s) and portable computing device 100. Data ports 128-132 can include, for example, input slot 128 that can be used to accept a memory card (such as a FLASH memory card), data ports 130 and 132 can take be used to accommodate data connections such as USB, FireWire, Thunderbolt, and so on. In some embodiments, speaker grid 134 can be used to port audio from an associated audio component enclosed within base portion 102. In one embodiment, microphones for capturing audio can be located in microphone region 136. Although not shown in FIG. 1, in other embodiments, microphones for capturing audio can be located in region 138.

FIG. 2 shows portable computing device 100 in a closed (lid) configuration that shows rear cover 122 and logo 202. In one embodiment, logo 202 can be illuminated by light from display 120. It should be noted that in the closed configuration, lid portion 108 and base portion 102 form what appears to be a uniform structure having a continuously varying and coherent shape that enhances both the look and feel of portable computing device 100.

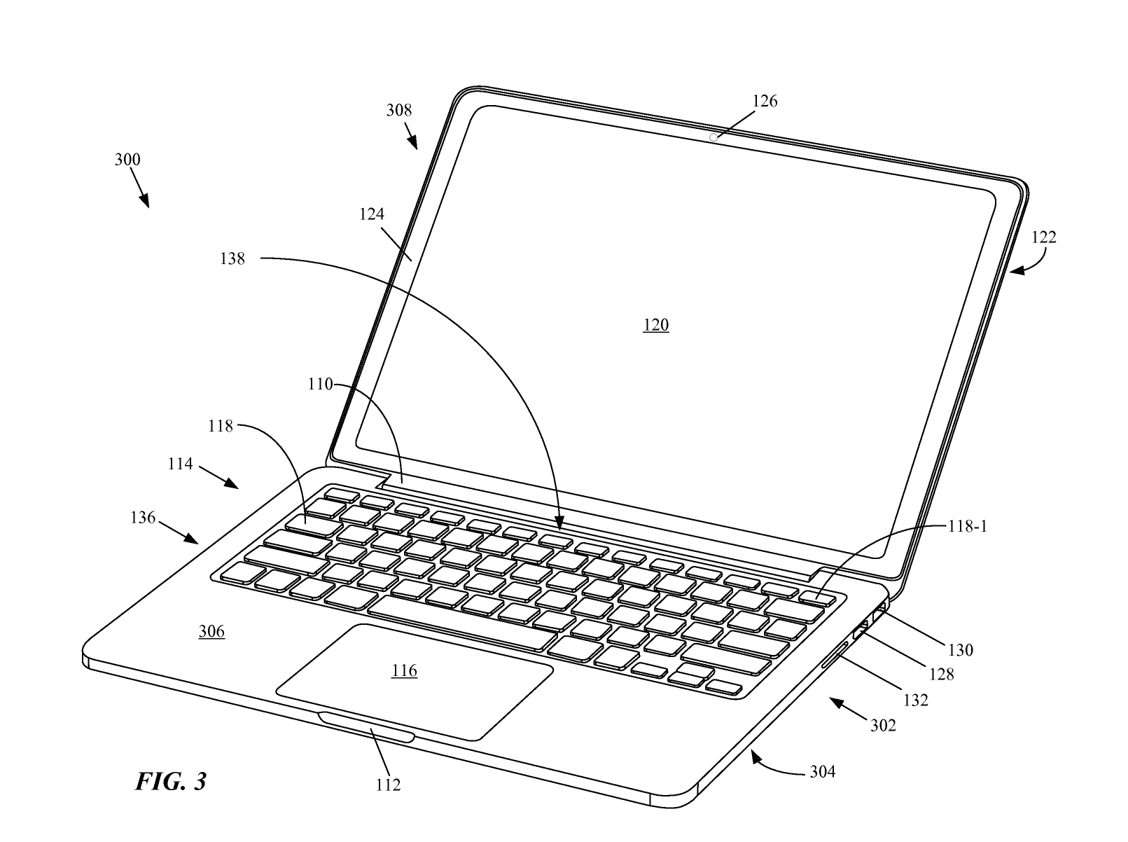

FIG. 3 shows another embodiment in the form of portable computing device 300 that is smaller than portable computing device 100. Since portable computing device 300 is smaller in size than portable computing device 100, certain features shown in FIG. 1 are modified, or in some cases lacking, in portable computing device 300. For example, base portion 302 can be reduced in size such that separate speakers (such as speaker grid 134) are replaced with an audio port embodied as part of keyboard 114. However, bottom case 304 and top case 306 can retain many of the features described with regards to portable computing device 100 (such as display 120 though reduced to an appropriate size). Similar to FIG. 1, in one embodiment, microphones for capturing audio can be located in microphone region 136. Although not shown in FIG. 3, in other embodiments, microphones for capturing audio can be located in region 138.

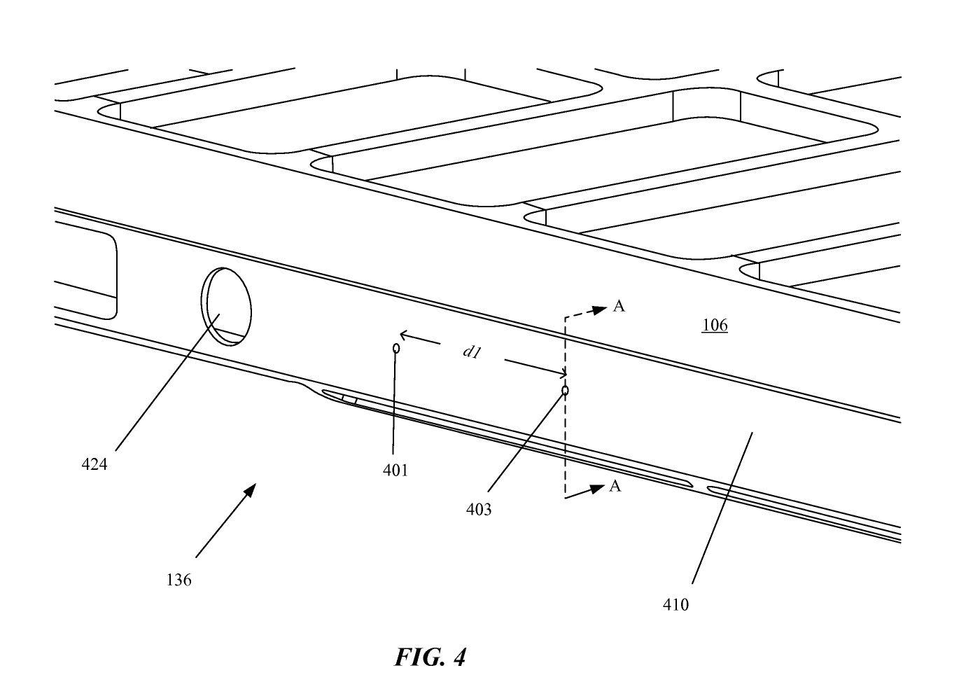

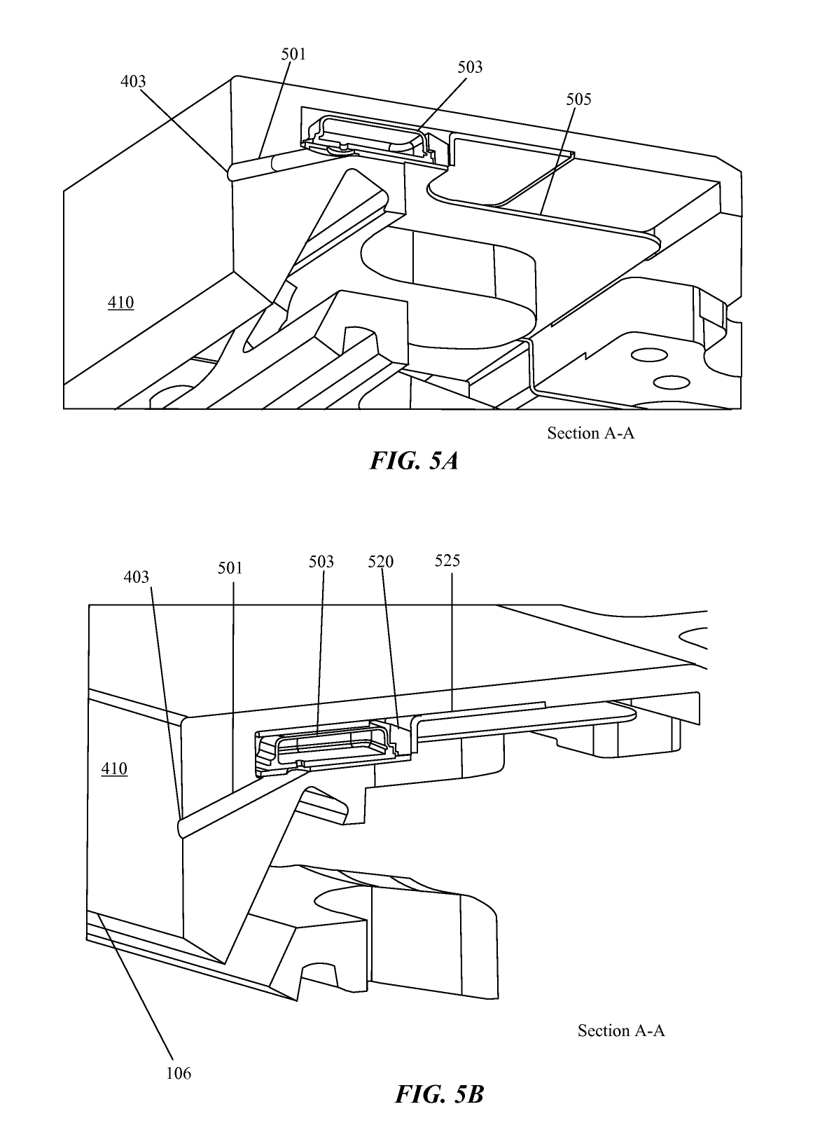

FIG. 4 shows microphone region 136 of top case 106 having first microphone opening 401 and second microphone opening 403 suitable for receiving audio signals. In this embodiment, microphone openings 401, 403 are disposed on sideband 410 of top case 106 and spaced apart distance “d1” in order to facilitate error correction in speech recognition algorithms. Distance d1 can vary depending upon a desired frequency response. For example, distance d can be on the order of about 15 mm. In other embodiments, microphone openings 401, 403 can be spaced apart a distance between 10 and 30 mm. In one embodiment, microphone openings 401 and 403 can be substantially perpendicular to users of portable computing device 100. Such a positioning of microphone openings can advantageously remove the openings from a line of sight of the user. Microphone openings 401, 403 can be substantially centered vertically (as shown) on side of top case 106. In one embodiment, microphone openings 401, 403 can take the form of an ellipse. In another embodiment, openings 401 and 403 can be substantially circular. Although not readily apparent from FIG. 5, microphone openings 401, 403 can be part of an internal microphone system. In one case, the microphone openings 401, 403 can lead to audio ports (cavities) that lead to an audio circuit having a transducer for converting audio signals (in the form of a voice, for example) into digital data for subsequent processing. The audio ports can be formed as part of top case 106. In other embodiments, more than two microphone openings can be disposed on sideband 410. In those embodiments, spacing between microphone openings need not be equal, but can be different. For example the distance between a first and a second microphone opening can be 15 mm, while the distance between the second and a third microphone openings can be 20 mm. Different microphone opening spacing can enable different available frequency responses compared to an embodiment with only two microphones. Top case 106 can also include an opening for a headphone jack 424.

FIGS. 5A-5B are cross section views of microphone openings 401, 403 from FIG. 4. FIG. 5A in particular, is a bottom view of cross section A-A. Although FIG. 5A is a cross section of microphone opening 403, cross section of microphone opening 401 can be substantially similar. Microphone opening 403 is shown on sideband 410. In one embodiment, the diameter of cavity 501 is 0.5 millimeters. In other embodiments, the diameter of cavity 501 can range from 0.5 to 1.00 mm. Other embodiments can include other diameters. Microphone 503 can be aligned with cavity 501 such that the opening of microphone 503 can be substantially centered with cavity 501. In one embodiment, cavity 501 can act as a resonant cavity coupling microphone opening 403 to microphone 503. The resonant cavity can affect, at least in part, a frequency response of microphone 503. Microphone 503 can be attached to a substrate 505 and couple signals from microphone 503 to other devices or circuits. Substrate 505 can be a printed circuit board, flexible circuit, rigid flex or any other technically feasible substrate. In one embodiment, microphone 503 can be sealed to cavity 501 to improve acoustic performance and reduce sensitivity to stray noise.

FIG. 5B shows a top view of cross section A-A from FIG. 5. Microphone opening 403 is shown on sideband 410. Microphone 503 can be positioned with respect to top case 106, by carrier 520, mounting flange 525 or a combination of both. In one embodiment, cavity 501 can be configured at an angle with respect to sideband 403. In one embodiment, cavity 501 can be fifteen degrees in elevation with respect to a top or bottom surface of top case 106. In one embodiment, microphones associated with both first and second microphone openings 401 and 403 can be configured substantially similar to the configuration shown FIGS. 5A-5B. By configuring the microphone openings 401, 403, related cavities and related microphones substantially similar, acoustic performance aspects of individual microphones can be substantially similar, enhancing the performance of a microphone array based on microphones coupled to first and second microphone openings 401, 403. In one embodiment, microphone openings 401 and 403 can be co-planar on sideband 410.

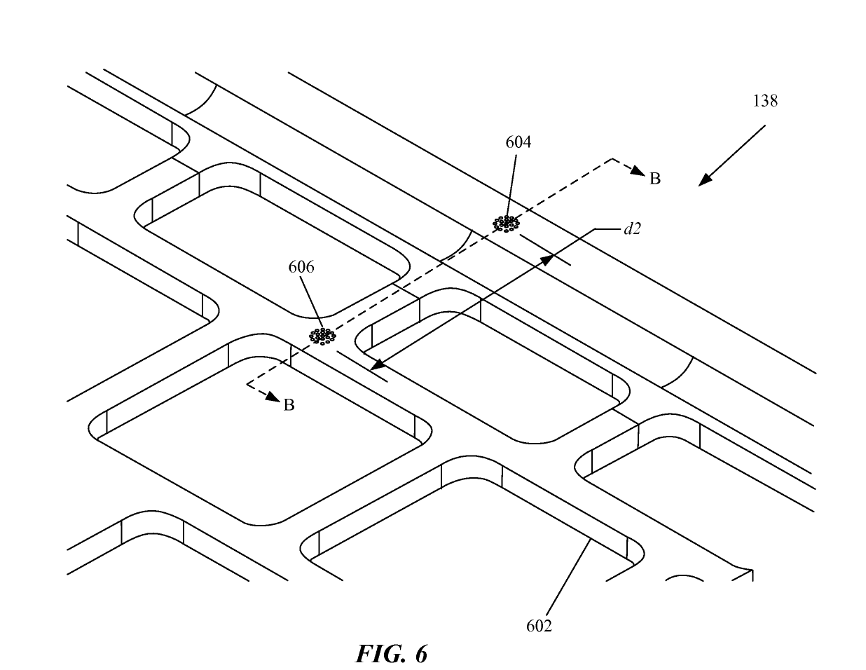

FIG. 6 shows microphone region 138 of top case 106 in accordance with one embodiment of the specification. Microphone region 138 can be disposed on keyboard web 602. The exemplary embodiment shown in FIG. 6 shows two microphone openings positioned on keyboard web 602. In one embodiment, the distance d separating first microphone opening 604 and second microphone opening 606 can be between 15 and 20 mm. First microphone opening 604 can be disposed toward one edge of keyboard 602, adjacent to the area for keyboard 114. Second microphone opening 606 can be positioned between key openings on keyboard web 602. In one embodiment, microphone openings 604 and 606 can be centered horizontally on keyboard web 602 such that microphone openings 604 and 606 can be substantially equally distant from right and left edges of the portable computing device 100. This microphone position can advantageously center the microphone openings 604 and 606 substantially in-line with the user.

Microphone separation distance d2 between first microphone opening 604 and second microphone opening 606 can be selected to enable microphones coupled to first 604 and second 606 microphone openings to increase a frequency response in a frequency band. In one embodiment, a separation of 15 mm can enhance a frequency response around 8 KHz, which can be a frequency related to human voices.

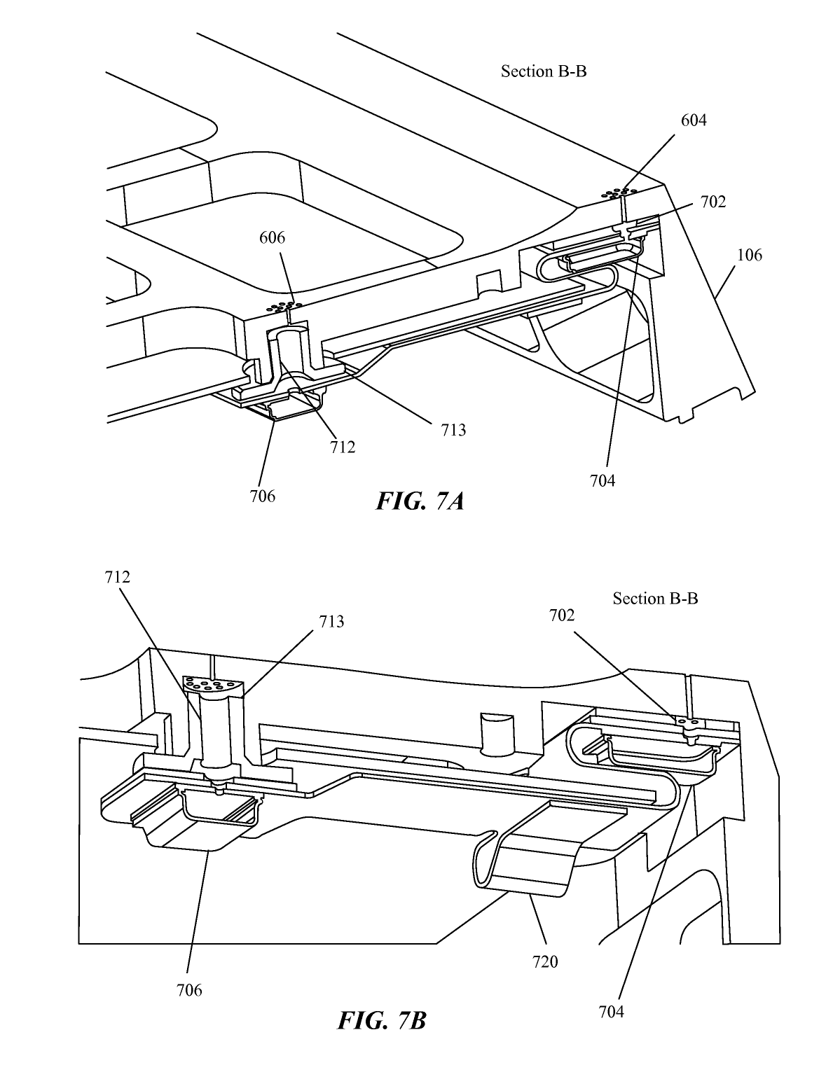

FIGS. 7A and 7B are cross section views of microphone openings shown in FIG. 7. FIG. 7A shows cross section B-B, as viewed from the top of keyboard web 602. Keyboard web 602 can include first microphone opening 604 and second microphone opening 606. First microphone 704 can be aligned with first microphone opening 604. In one embodiment, first cavity 702 can be disposed between and couple first microphone 704 to first microphone opening 604 and first cavity 702 can also function as a resonant cavity to shape an audio frequency response of the first microphone 704. In one embodiment, first cavity can be formed keyboard web 602.

Second microphone 706 can be aligned with second microphone opening 606. Second cavity 712 can couple second microphone 706 to second microphone opening 606. In one embodiment, second cavity 712 can be formed by fastener 713 where a central portion of the fastener 713 is removed. In one embodiment, fastener 713 can be a machined screw. The fastener 713 can be used to attach a keyboard assembly to the top case 106 as well as act as second cavity 712. In one embodiment, the dimensions of the central portions of fastener 713 can define, at least in part, related resonant cavity characteristics.

FIG. 7B is a bottom view of cross section B-B from FIG. 7. First cavity 702 and second cavity 712 are shown. First microphone 704 and second microphone 706 can be affixed to a common substrate 720 to ease manufacturing and help route microphone signals. The substrate 720 can be a flex circuit, rigid flex circuit, or any other technically feasible substrate. In one embodiment, first microphone 704 and second microphone 706 can be sealed to first cavity 702 and second cavity 712 respectively to increase acoustic performance and reduce sensitivity to stray noise sources.

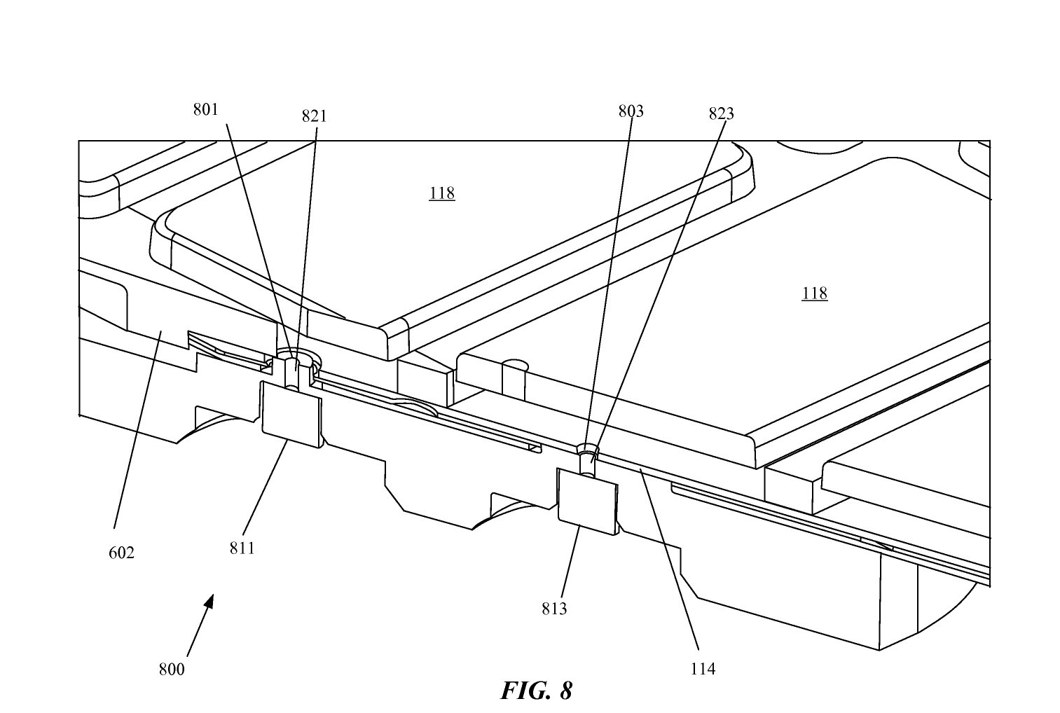

FIG. 8 is a cross section view of another embodiment of a microphone region 800 on top case 106. In this embodiment, microphone openings 801 and 803 can be placed underneath keycaps 118 of a keyboard 114 of portable computing device 100. First microphone 811 and second microphone 813 can be disposed underneath keyboard web 602. In one embodiment, first and second microphone openings 801 and 803 can be spaced 15 millimeters apart. In other embodiments, microphone spacing can be between 10 and 30 millimeters apart. First cavity 821 can couple first microphone 811 to first microphone opening 801 and second cavity 823 can couple second microphone 813 to second microphone opening 803. In one embodiment, cavities 821 and 823 in keyboard web 602 can also serve, at least in part, as resonant cavities to help shape the frequency response of microphones 811 and 813. As shown, microphone openings 801 and 803 can be advantageously hidden underneath keycaps 118.

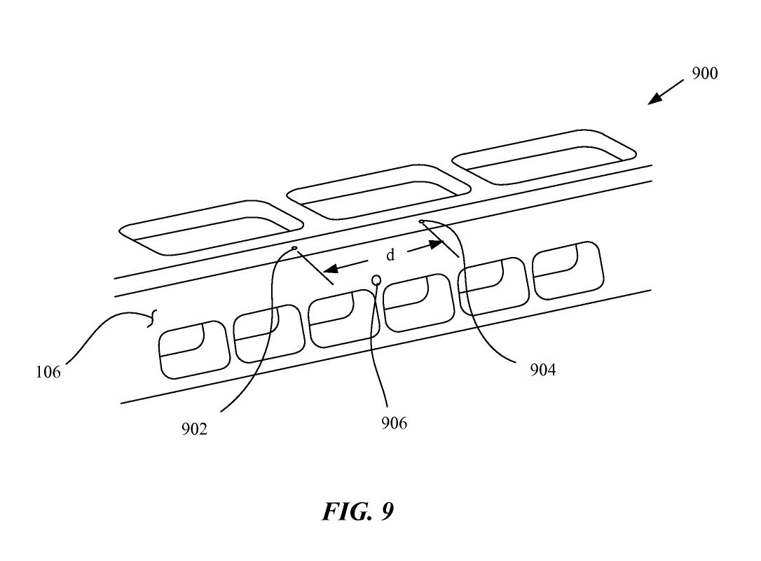

FIG. 9 is a view of another embodiment of a microphone region 900. In this embodiment, two microphone openings can be disposed on an upper region of top case 106. As shown, a first microphone opening 902 and a second microphone opening 904 can be disposed on a rear portion of top case 106 above the keyboard web. In one embodiment, the first and the second microphone openings 902 and 904 can be separated by a distance d. As described above, the distance d can be selected to facilitate detection and error correction in speech recognition algorithms. In one embodiment, distance d can vary depending upon a desired frequency response. Microphone region 900 can include a third microphone opening 906 disposed on a rear facing portion of top case 106. In one embodiment, the third microphone opening 906 can be disposed near rear vents co-located on the rear facing portion of top case 106.

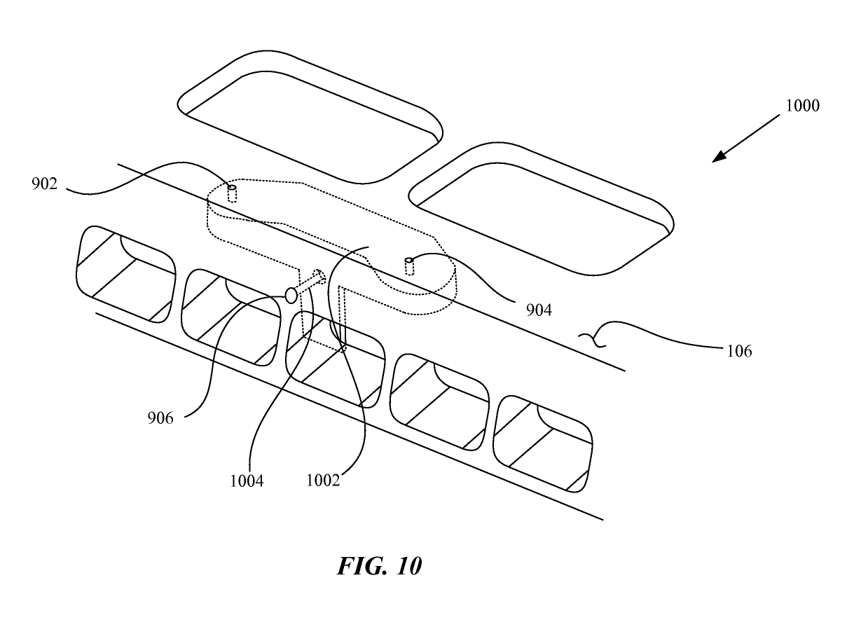

FIG. 10 shows another view of the microphone region 1000 shown in FIG. 9 including a microphone assembly 1002. Microphone assembly 1002 can support three microphones configured to receive audio signals. In one embodiment, microphone assembly 1002 can include a flexible cable configured to act as a mounting substrate for the three microphones. As shown, the first microphone opening 902 and the second microphone opening 904 can be disposed on an upper region of top case 106. The third microphone opening 906 can be formed in two steps. A first step can form an acoustic cavity 1004 between an outer surface of top case 106 and an inner surface of top case 106 in the region of a third microphone. A second step can shape a surface feature of acoustic cavity 1004 to be substantially round. The second step can mask an ellipsoid shape that can result when acoustic cavity 1004 is formed at an angle with respect to the rear facing wall of top case 106.

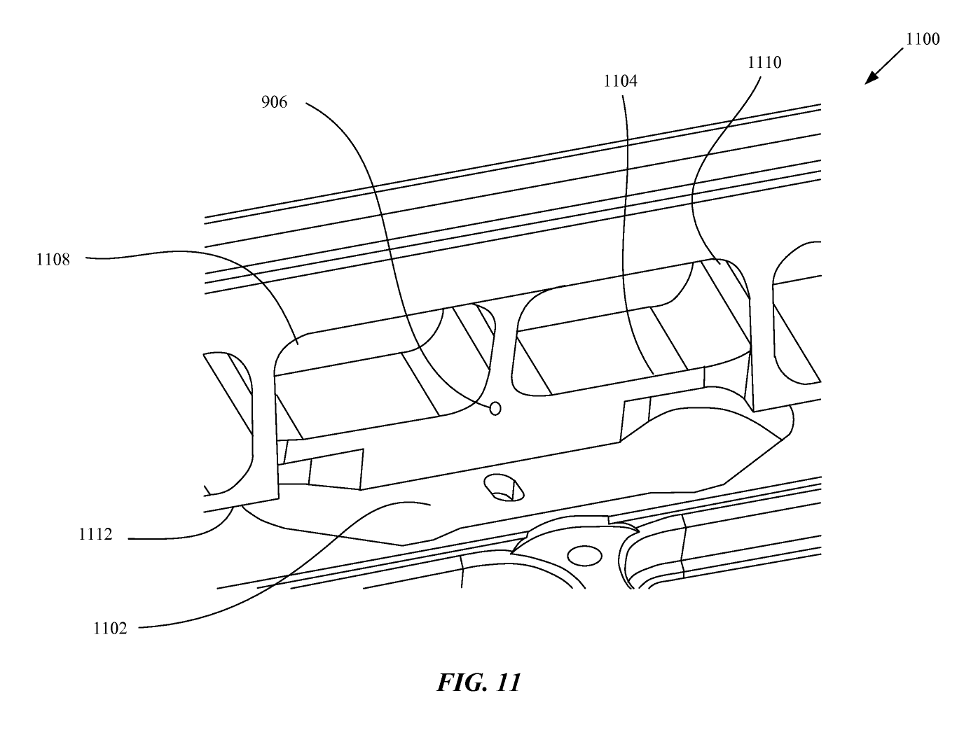

FIG. 11 shows an interior view of top case 106 near the microphone region of FIG. 9. The third microphone opening 906 is shown in relation to rear vents 1108 and 1110. In one embodiment, a mounting surface 1102 can be formed in top case 106 for top facing microphones. In one embodiment, an edge of rear vents 1108 and 1110 can be shaped to accommodate top facing microphones. In some embodiments, edge 1104 of vents 1108 and 1110 can be uniformly shaped with respect to each other, but in contrast to other vent edges 1112.

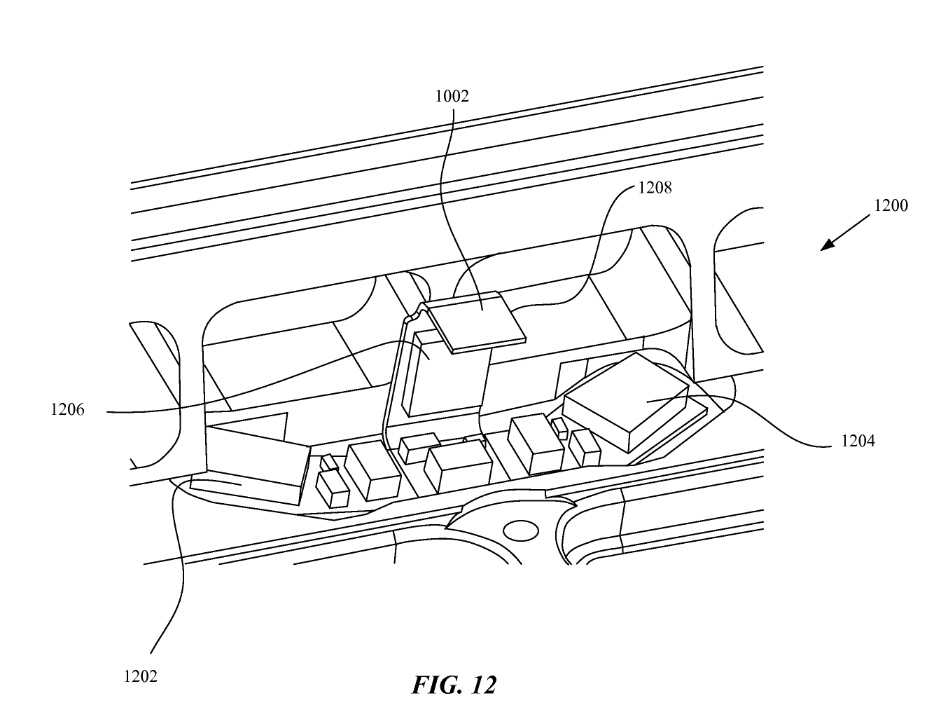

FIG. 12 shows an interior view of top case 106 near the microphone region of FIG. 9 with microphone assembly 1002. Microphone assembly 1002 can include a first microphone 1202 that can be coupled to the first microphone opening 902, a second microphone 1204 that can be coupled to the second microphone opening 904 and a third microphone 1206 that can be coupled to the third microphone opening 906. A flexible cable 1208 can act as a mounting substrate for the microphones. The first and second microphones 1202 and 1204 can be disposed adjacent to mounting surface 1102.

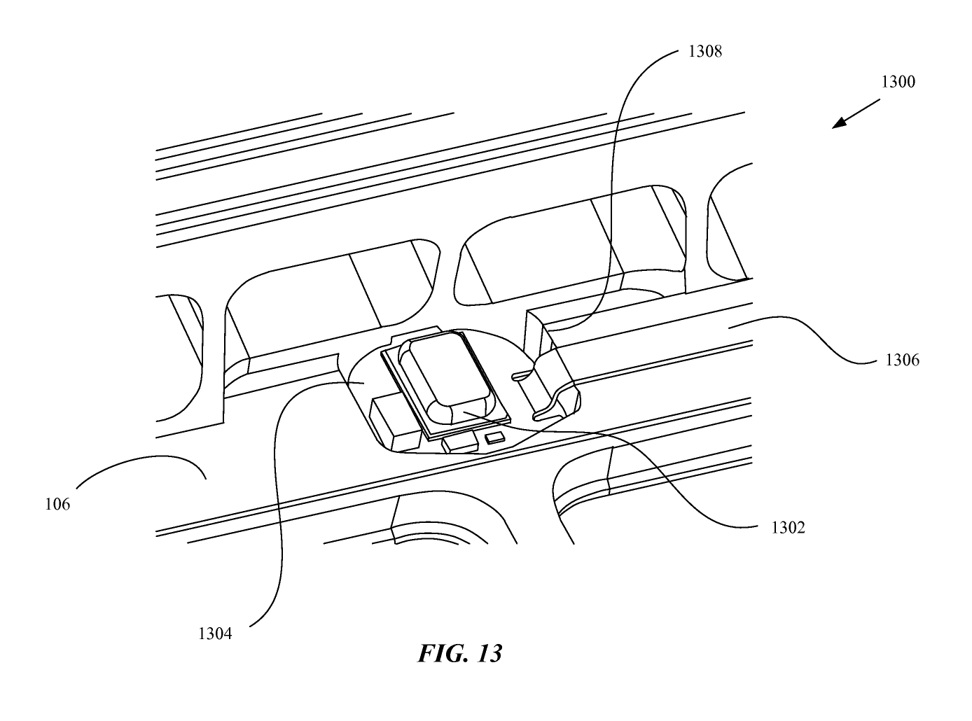

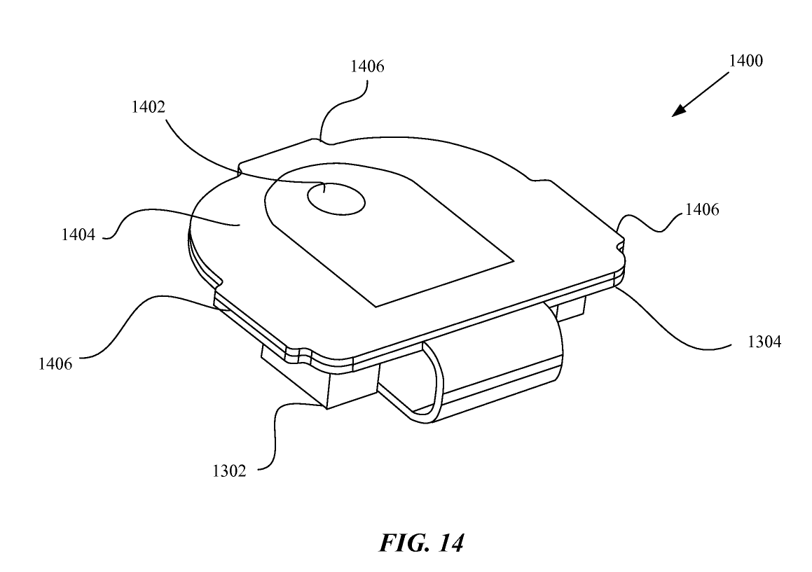

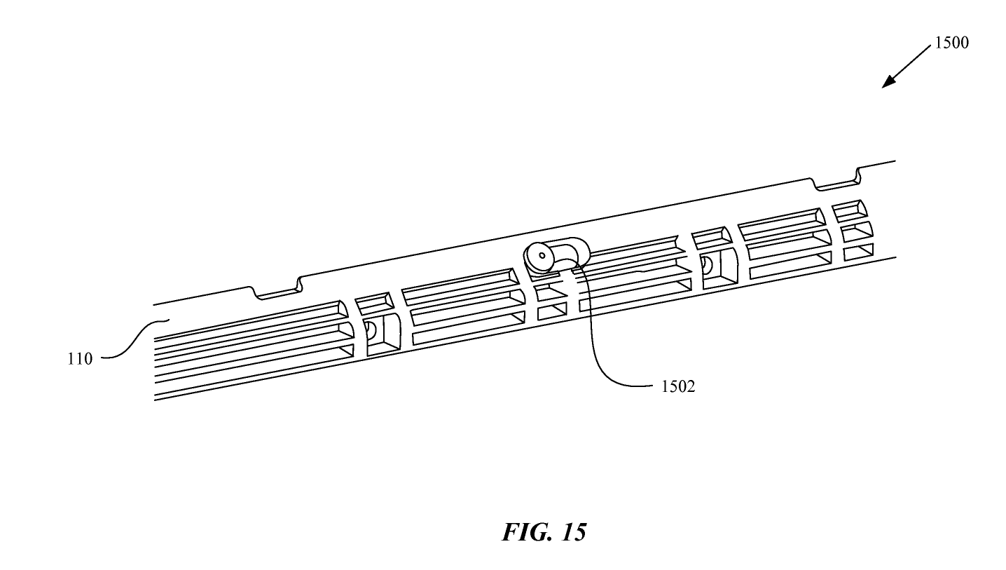

In another embodiment of a microphone region, a first microphone opening can be disposed on a upper region of top case 106 (similar to microphone opening 902 shown in FIG. 9) and a second microphone can be disposed within clutch assembly 110. FIG. 13 shows an internal view 1300 of top case 106 in the region of a first microphone 1302 disposed on an upper region of top case 106. First microphone can be affixed to a mounting substrate 1304. A flexible cable 1306 can be coupled to first microphone 1302 and can carry electrical signals from first microphone 1302 to audio processing circuitry. The first microphone 1302 and mounting substrate 1304 can be configured to mount within a well 1308 formed in top case 106. FIG. 14 shows a reverse view 1400 of the mounting substrate 1304. The first microphone 1302 can include a microphone port 1402 that can be accurately aligned with an acoustic cavity in the top case 106 configured to receive acoustic sounds. One or more tabs 1406 can be formed in the mounting substrate 1304 to help accurately locate the microphone port 1402 to a selected acoustic cavity. In some embodiments, a gasket 1404 can be used to help seal microphone 1302 to top case 106. In yet other embodiments, gasket 1404 can include an adhesive layer configured to affix microphone 1302 and substrate 1304 to top case 106. FIG. 15 shows an internal view of a clutch assembly 110 including a second microphone 1502. The first microphone 1302 and the second microphone 1520 can be used together to perform acoustic detection and error correction in speech recognition algorithms. In one embodiment, distance between the first and the second microphones can vary depending upon a desired frequency response.

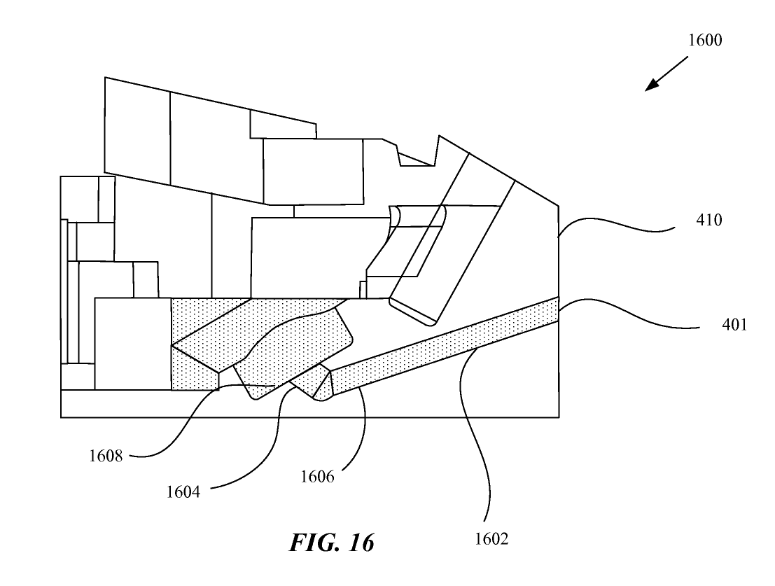

FIG. 16 is a cross sectional view A-A 1600 of another embodiment of a microphone region configured to include sideband 410 microphone openings as shown in FIG. 4. Although the cross section 1600 shows a single microphone region, first and second microphone regions can be substantially similar. The first microphone opening 401 can be coupled to a first acoustic cavity 1606 formed with a first segment 1602 and a second segment 1604. In one embodiment, the first acoustic cavity 1606 can be configured to enhance a frequency response of a first microphone. In one embodiment, the diameter of the first segment can be about 0.7 mm. The first microphone can be mounted to a first microphone mounting surface 1608. One method for forming the first acoustic cavity 1606 can include the steps of forming the first segment 1602 by machining the first segment 1602 from the outside of the top case 106 and then forming the second segment 1604 by machining the second segment from inside the top case 106. In one embodiment, pulsating air can be used to flush debris from the first acoustic cavity 1606 and to continue to prevent foreign material from settling within the first acoustic cavity 1606.

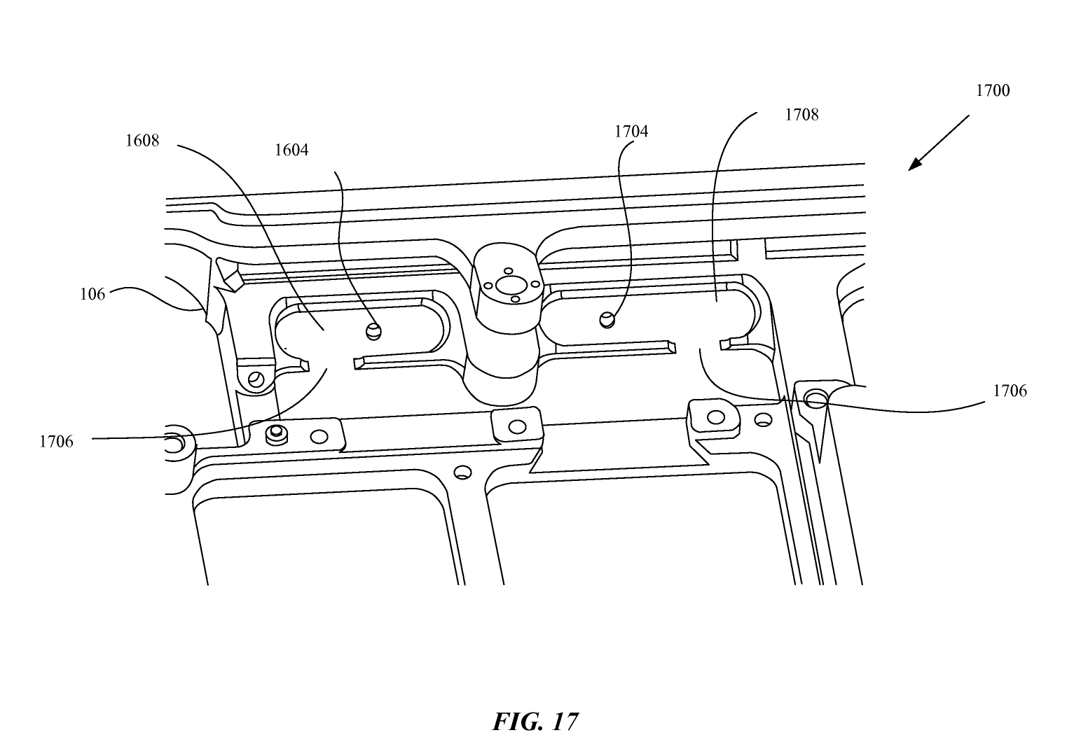

FIG. 17 is an interior view 1700 of the top case 106 in the region of the cross section shown in FIG. 16. The second segment 1604 of the first acoustic cavity 1606 is shown within the first microphone mounting surface 1608. The first acoustic cavity 1606 can be coupled to the first microphone opening 401 of FIG. 4. A second segment 1704 of a second acoustic cavity is shown within a second microphone mounting surface 1708. The second acoustic cavity can be coupled to the second microphone opening 403 of FIG. 4. One or more notches 1706 can be formed on an interior surface of top case 106 to accommodate flexible cables that can be used to couple signals from first and second microphones to electrical circuitry.

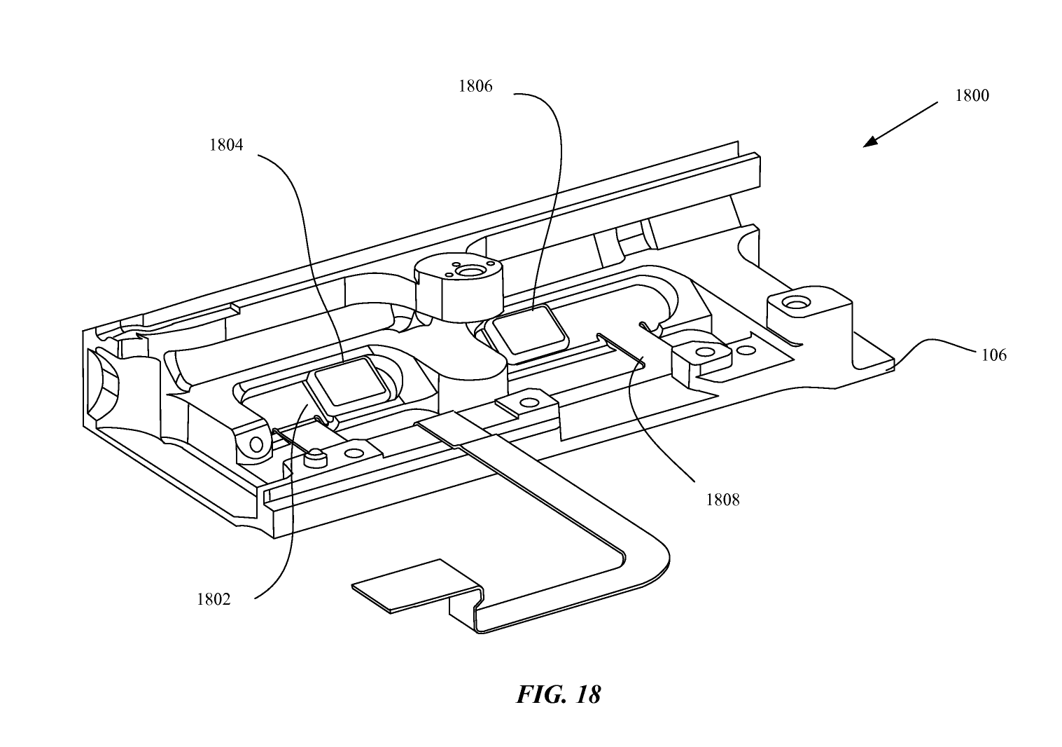

FIG. 18 is an interior view 1800 of the top case 106 in the region of the cross section shown in FIG. 16 including a microphone assembly 1802. The microphone assembly 1802 can include a first microphone 1804 and a second microphone 1806. In one embodiment, the first and second microphones 1804, 1806 can be mounted to a flexible circuit 1808. In one embodiment, first microphone 1804 can be coupled to first microphone opening 401 and second microphone 1806 can be coupled to second microphone opening 403. In another embodiment, the flexible circuit 1808 can include an adhesive, such as a pressure sensitive adhesive to affix the microphone assembly 1802 to the top case 106. In particular, regions of the flexible circuit 1808 that can contact the first and second microphone mounting surfaces 1608, 1708 can include a pressure sensitive adhesive.

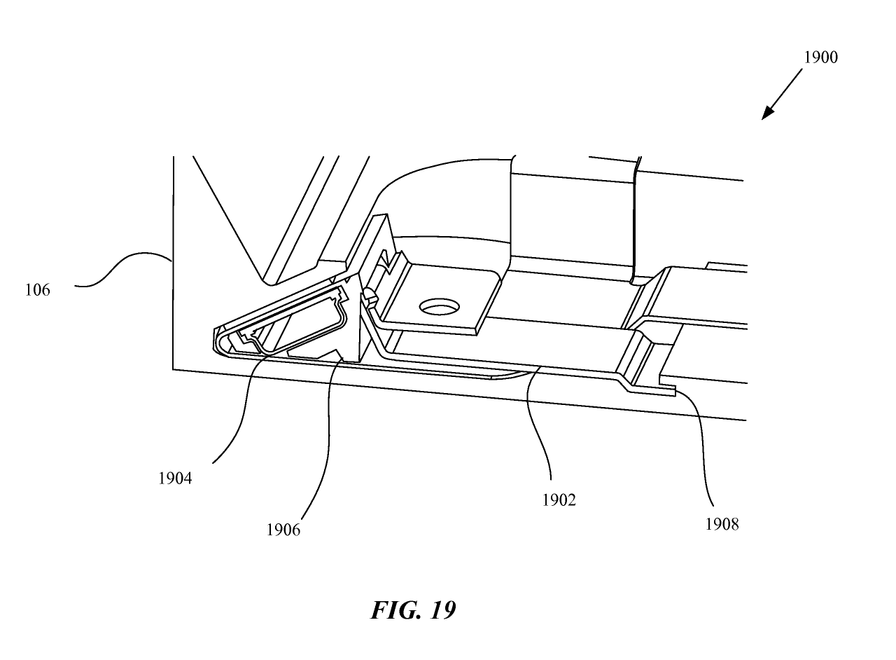

FIG. 19 shows one embodiment 1900 of bi-stable spring 1902 configured to affix a microphone assembly in place with respect to top case 106. A microphone 1904 can be disposed within a holder 1906. The holder 1906 can be configured to position the microphone 1904 at a proper mating angle to engage a microphone mounting surface formed within top case 106. In one embodiment, the microphone mounting surface can be similar to microphone mounting surface 1608 illustrated in FIG. 16. A bi-stable spring 1902 can be configured to engage a notch 1908 formed in top case 106 and force microphone holder 1906 against the microphone mounting surface. The bi-stable spring 1902 can enable relatively easy removal of microphone 1904 since no adhesive is used to attach the microphone 1904 to the top case 106.

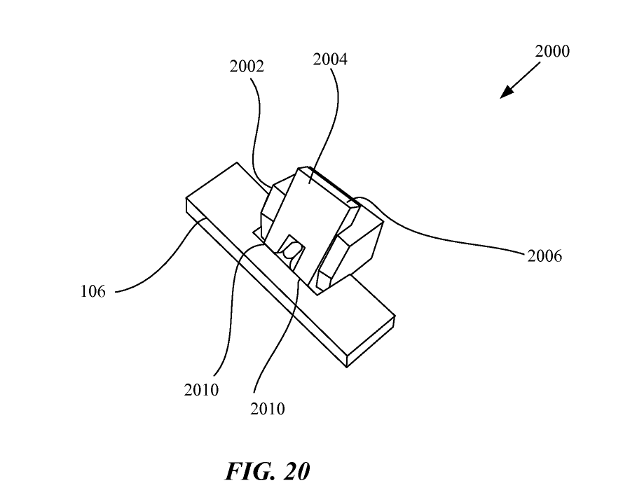

FIG. 20 shows a fixture for applying pressure to a microphone assembly to assist in mounting the microphone assembly in top case 106. In one embodiment, the microphone assembly 1802 can be as described in FIG. 18. When microphone assembly 1802 includes a pressure sensitive adhesive, the assembly 1802 can be forced, at least temporarily, against a surface of top case 106 to help ensure contact of the adhesive between the assembly 1802 and the top case 106. In some embodiments, access to the microphone assembly 1802 can be limited. A fixture can be used to properly apply pressure to the microphone assembly 1802 without damaging microphones 1804 and 1806. FIG. 20A shows one embodiment of the fixture that can include two pieces: a plunger support 2002 and a plunger 2004. The plunger support 2002 can use existing features formed within top case 106 to establish a proper position with respect to microphone assembly 1802. Plunger 2004 can be supported at an angle by plunger support 2002. Plunger 2004 can include a first surface 2006 configured to receive a bonding pressure. The bonding pressure is transferred to surfaces 2010 that can be placed against microphone assembly 1802. An angled surface on plunger support 2002 can ensure that bonding pressure is delivered to surfaces 2010 at a correct orientation. By splitting surfaces 2010 into two distinct surfaces, pressure can be individually applied to the first and the second microphones 1804 and 1806 respectively.

Although the foregoing invention has been described in detail by way of illustration and example for purposes of clarity and understanding, it will be recognized that the above described invention may be embodied in numerous other specific variations and embodiments without departing from the spirit or essential characteristics of the invention. Certain changes and modifications may be practiced, and it is understood that the invention is not to be limited by the foregoing details, but rather is to be defined by the scope of the appended claims.

What is claimed is:

1. A microphone assembly for a portable computing device, the assembly, comprising:
a first microphone opening disposed on an upper surface of a base portion of the portable computing device;
a second microphone opening disposed on a rear facing surface of the base portion of the portable computing device;
a first microphone coupled to the first microphone opening configured to receive audio signals; and
a second microphone coupled to the second microphone opening configured to receive audio signals.

2. The assembly of claim 1, wherein the first and the second microphones are coupled to a flexible cable.

3. The assembly of claim 1, wherein the second microphone opening is disposed near rear vents included in the base portion of the portable computing device.

4. The assembly of claim 3, wherein at least one of the rear vents adjacent to the second microphone opening is shaped to provide a uniform edge in a region near the second microphone opening.

5. The assembly of claim 1, further comprising a third microphone opening disposed on the upper surface of the base portion of the portable computing device.

6. The assembly of claim 5, wherein the first microphone opening is separated by a distance d from the third microphone opening wherein the distance d is configured to enhance a frequency response of the first and the third microphones.

7. A microphone assembly for a portable computing device, the assembly comprising:
a first microphone opening disposed on a sideband of a base portion of the portable computing device;
a first microphone configured to receive audio signals;
a first acoustic cavity comprising a first segment and a second segment configured to couple the first microphone opening to the first microphone, wherein the acoustic cavity is configured to have a particular frequency response.

8. The assembly of claim 7, wherein a portion of the first segment of the first acoustic cavity is disposed on the sideband forming the first microphone opening.

9. The assembly of claim 7, wherein a portion of the second segment of the first acoustic cavity is coupled to the first microphone.

10. The assembly of claim 7, further comprising:
a second microphone opening disposed on the sideband a distance d from the first microphone;
a second microphone configured to receive audio signals;
a second acoustic cavity comprising a third and a fourth segments configured to couple the second microphone opening to the second microphone.

11. The assembly of claim 10, wherein the base portion includes an inner surface configured to accept a surface of the first and the second microphones.

12. The assembly of claim 11, wherein the base portion further comprises a notch configured to accept a flexible cable.

13. The assembly of claim 12, wherein the first and the second microphones are coupled to a flexible cable.

14. The assembly of claim 10, further comprising a bi-stable spring configured to hold at least one microphone in place against a surface of the base portion.

15. The assembly of claim 10, wherein the first and second segments are substantially similar to the third and fourth segments respectively.

16. The assembly of claim 10, wherein the distance d is selected to enhance a frequency response of the first and the second microphones.

17. A fixture for applying a bonding pressure to a microphone assembly for use in a portable computing device, the fixture comprising:
a plunger support configured to align with features included in a top case of a portable computing device; and
a plunger configured to be supported by the plunger support and including a first surface configured to contact a first microphone and a second surface configured to receive pressure and transmit the pressure to the first microphone.

18. The fixture of claim 17, wherein the plunger is divided into a first portion and a second portion, wherein the first portion includes the first surface and the second surface and a second portion includes a third surface configured to contact a second microphone and a fourth surface configured to receive bonding pressure and transmit the bonding pressure to the second microphone.

19. The fixture of claim 18, wherein the first portion and the second portions of the plunger can be actuated separately.

20. The fixture of claim 17, wherein a first bonding pressure can be applied to the first microphone and a second bonding pressure different from the first bonding pressure can be applied to a second microphone.
